(19) United States
(12) Patent Application Publication
(10) Pub. No.: US 2004/0049484 A1
(43) Pub. Date: Mar. 11, 2004

(54) Method and apparatus for separating and extracting information on physiological functions

(75) Inventor: Masayuki Kamba, Tokyo (JP)

Correspondence Address: Law Offices of Townsend & Banta, Suite 900, South Building, 601 Pennsylvania Avenue, N.W., Washington, DC, 20004, US

(73) Assignee: Hamano Life Science Research Foundation

(21) Appl. No.: 10/462,642

(22) Filed: Jun. 17, 2003

(30) Foreign Application Priority Data
Sep. 11, 2002 (JP) 2002-265051

(51) Int. Cl. G06F 7/00

(52) U.S. Cl. 707/1

(57) ABSTRACT

Signal components of different physiological origins are accurately separated and information about each component is provided, even when a signal change related to local neuronal activity and signal fluctuations related to other physiological origins coexist. It is achieved by a method for separating and extracting information on physiological functions, wherein a mathematical model is built to describe an input/output relationship for functional measurement data on a pixel or channel basis, and information on signal components of various physiological origins is separated and extracted from the functional measurement data.

### BACKGROUND OF THE INVENTION

1. Field of the Invention

The present invention relates to a method and an apparatus for separating and extracting information on physiological functions in which, from functional measurement data obtained by the magnetic resonance imaging, near-infrared spectroscopy or the like, signal components of various physiological origins are separated and extracted, and pieces of information on the respective components are displayed.

2. Description of the Related Art

In recent years, functional measurement techniques including magnetic resonance imaging and near-infrared spectroscopy have been widely used as noninvasive methods for brain functional measurements. Measured data obtained by these methods is affected by signal changes caused by not only local neuronal activities but also a wide variety of physiological phenomena, such as systemic circulation, respiration, autonomic nervous activities and vasomotion. Of the physiological phenomena, as for cardiac pulsation and respiration, which are easy to measure, comparison between frequency components thereof and frequency components of the functional measurement data has proved that the functional measurement data contains signal components for these physiological phenomena (Ogawa S, et al, Visualization of Information Processing in the Human Brain: Recent Advances in MEG and Functional MRI (EEG Suppl. 47), 1996, pp. 5-14; Mitra P P, et al, Magn Reson Med, 1997; 37: 511-8; Lowe M J, et al, Neuroimage, 1998; 7: 119-32).

In applications of brain functional studies, preprocessing such as trend removal or low-pass filtering is used on the basis of the difference in frequency components between signal changes caused by local neuronal activities and those caused by above-mentioned physiological phenomena (Friston K J, et al, Human Brain Mapping, 1995; 2: 189-210; Strupp J P, Neuroimage, 1996; 3: S607).

In the past, in order to extract signal changes caused by local neuronal activity, statistical tests for difference in measured values between periods of neuronal activation and periods of baseline have been used for determining active sites with a statistical significance. Another method is determining a correlation between the measured values and a presupposed pattern of signal change caused by neuronal activation (Strupp J P, Neuroimage, 1996; 3: S607). Besides, a general linear model, which is an extension of these methods, has been used (Friston K J, et al, Human Brain Mapping, 1995; 2: 189-210). Furthermore, in order to estimate a response pattern for a region of interest, event-related signal averaging or curve fitting based on a presupposed response pattern has been used. Recently, independent component analysis has been applied to decomposition of signal components of different origins (Gu H, et al, Neuroimage, 2001; 14: 1432-43).

On the other hand, signal fluctuations related to physiological phenomena other than local neuronal activities have been considered disturbances, and extraction of local function of such physiological phenomena from the functional measurement data has not been yet made.

### SUMMARY OF THE INVENTION

Physiological phenomena that affect functional measurement data include circulation, respiration, autonomic nervous activities and vasomotion. According to the methods described above, effects of physiological fluctuations which are largely different from the signal changes related to local neuronal activities in frequency, such as cardiac pulsation and respiration, and effects of fluctuations in minutes of arterial blood pressure and arterial partial pressure of carbon dioxide can be readily removed. However, for example, effects of arterial blood pressure fluctuations caused by baroreflex and vasomotion cannot be removed. Therefore, in order to remove these effects, it is required to increase the statistical power by increasing the number of data samples. However, these physiological fluctuations may not be always independent of an activation paradigm, and increasing the number of data samples cannot always provide a test or estimation result without bias. Furthermore, if these effects are strong, above-mentioned methods may lead to unreliable results. If an independent component analysis is used, it is not always easy to interpret physiological basis of the decomposed signals. Furthermore, the strength of the effects of these physiological phenomena on the functional measurement data is spatially uneven. In addition, in terms of time, there are synchronous or asynchronous effects of physiological phenomena.

An object of the invention is to, even when a signal change related to local neuronal activity and signal fluctuations related to other physiological origins coexist, separate accurately signal components of different physiological origins and provide information about each component. In addition, another object of the invention is to provide, in a form readily understood, temporal or spatial characteristics of signal components of different physiological origins in functional measurement data.

The objects described above are attained by a method for separating and extracting information on physiological functions, in which a mathematical model is built to describe an input/output relationship for functional measurement data on a pixel or channel basis, and information on signal components of different physiological origins is separated and extracted from the functional measurement data.

Here, an extracted function may be a function of the central nervous system or a local physiological function. In addition, in building the mathematical model, a representative signal value of the functional measurement data, measured values of systemic physiological functions, or stochastic noise may be used.

In addition, the separated and extracted information on physiological functions can be visualized. In visualizing the information on physiological functions, simulation based on a model may be used, a distribution of or spatial information about noise contribution (power contribution) may be visualized, a distribution of or spatial information about model properties may be visualized, or a distribution of or spatial information about stochastic noise may be visualized.

An apparatus for separating and extracting information on physiological functions according to the invention comprises means of building a mathematical model which describes an input/output relationship for functional measurement data on a pixel or channel basis, and separating and extracting information on signal components of different physiological origins from the functional measurement data. The separating and extracting apparatus may further comprise means of visualizing the separated and extracted information on physiological functions.

According to the invention, functional measurement data, for example, a magnetic resonance signal, a near-infrared spectrum or the like is used for analysis. The functional measurement data contains signal changes of various physiological origins. In general, changes in local neuronal activities lead to signal responses associated with an activation paradigm. However, the responses are uneven spatially or temporally. Other origins of physiological fluctuations include essential periodic activities of living bodies, such as cardiac pulsation and respiration, changes in arterial blood pressure related to an autonomic activity and changes in arterial partial pressure of carbon dioxide. These phenomena cause a synchronous signal change in the functional measurement data. However, the strength of the effects of these phenomena is spatially uneven. On the other hand, a signal fluctuation related to vasomotion, that is, periodic contraction and dilation of micro blood vessels varies in phase in different localities and is asynchronous. In addition, the strength thereof is also spatially uneven. If an appropriate mathematical model that describes an input/output relationship on a pixel or channel basis is built, it is possible to estimate spatial and temporal responses to various physiological fluctuations. According to the invention, a mathematical model receives, as inputs, a functional activation paradigm, physiological measurements obtained simultaneously, a reference signal created from functional measurement data, stochastic noise or the like and outputs functional measurement values for pixels or channels, thereby enabling separation and extraction of an effect of each input on the functional measurement values. Model parameters of the built mathematical model as well as a simulation of an output obtained by changing the inputs independently are visualized, thereby providing a temporal and spatial relationship between the input and the output in a form visually readily understood and attaining the objects described above. In a system in which the input components are correlated with each other, a contribution of each component to the signal changes of the other components is visualized, thereby providing a feedback relationship among the components in a form readily understood. In addition, as for a physiological fluctuation for which no distinct input can be specified, such as a signal fluctuation caused by vasomotion, a model is built using stochastic noise as an input, and the model parameters and characteristics of the physiological fluctuation component are provided in a form readily understood. Furthermore, according to the invention, sequentially collected data can be divided for separate use in model estimation and model validation, and thus, the validity of the built model can be checked. Alternatively, a model can be built by merging separately collected data with each other, and thus, constraints on data collection are reduced.

### BRIEF DESCRIPTION OF THE DRAWINGS

FIG. 1 is a flowchart of a procedure of separating and extracting information on functional activation;

FIGS. 2(a) and 2(b) illustrate methods for collecting functional data and physiological data, respectively;

FIG. 3 is a map showing a spatial distribution of gains corresponding to a brain functional activation input based on a model obtained by applying the invention;

FIG. 4 is a graph showing a distribution, on a complex plane, of a property of a model (poles) obtained by applying the invention;

FIG. 5 is a map showing, for each frequency band, a spatial distribution of a property of a model (poles) obtained by applying the invention;

FIG. 6 is a map showing, for each frequency band, a spatial distribution of a property of a model (zeros) obtained by applying the invention;

FIG. 7 is a map showing a spatial distribution of strength of stochastic noise of a model obtained by applying the invention;

FIG. 8 shows a result of simulation of time-course signal changes within human brain in the case where a pulsed input waveform is given as a brain functional activation input to a model obtained by applying the invention;

FIG. 9 is a graph showing a result of simulation of time-course signal change for one pixel in the case where a pulsed input waveform is given as a brain functional activation input to a model obtained by applying the invention;

FIG. 10 shows a result of simulation of time-course signal changes in human brain in the case where a pulsed input waveform is given as a change in averaged signal over the whole brain to a model obtained by applying the invention;

FIG. 11 is a graph showing a result of simulation of signal change for one pixel in the case where a pulsed input waveform is given as a change in averaged signal over the whole brain to a model obtained by applying the invention;

FIG. 12 is a graph showing noise (power) contributions of variables to a magnetic resonance signal based on a model obtained by applying the invention;

FIG. 13 is a map showing a spatial distribution of a noise (power) contribution of a pulse wave to magnetic resonance signals within a frequency band of 0.98 to 1.10 Hz, based on a model obtained by applying the invention;

FIG. 14 is a map showing a spatial distribution of a noise (power) contribution of a thoracic movement to magnetic resonance signals within a frequency band of 0.24 to 0.36 Hz, based on a model obtained by applying the invention; and

FIG. 15 is a map showing a spatial distribution of a noise (power) contribution of an end-tidal concentration of carbon dioxide to magnetic resonance signals within a frequency band of 0.04 to 0.16 Hz, based on a model obtained by applying the invention.

### DETAILED DESCRIPTION OF THE PREFERRED EMBODIMENTS

In the following, an embodiment of the invention will be described. FIG. 1 is a flowchart of a procedure of implementing the invention. Processing conducted in steps 1 to 6 in this flowchart will be described below.

(1) Measurement of Functional Data

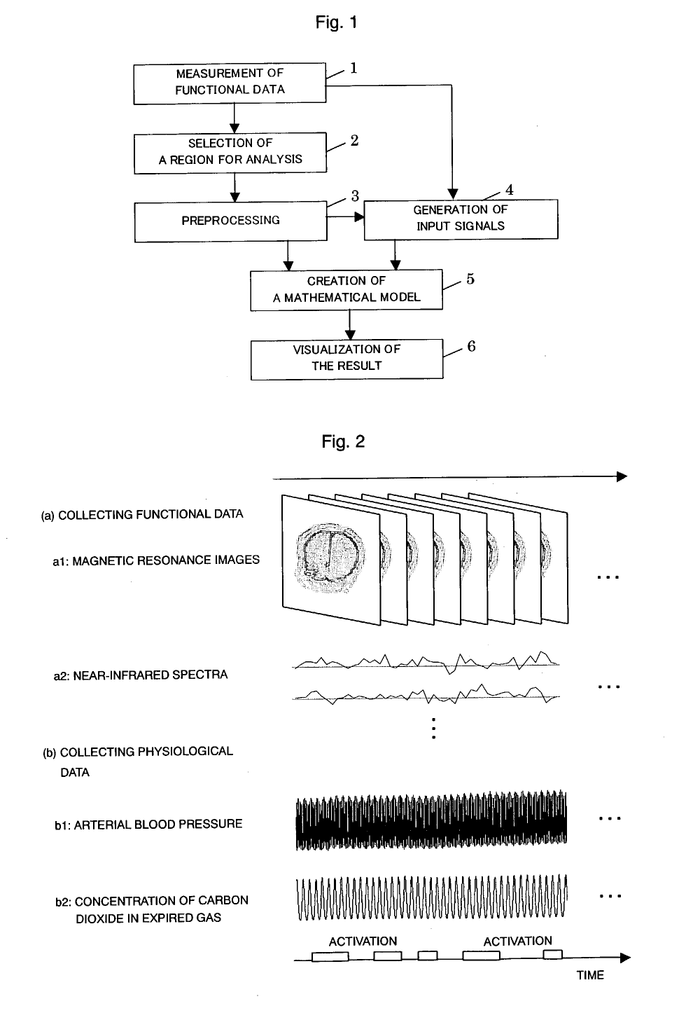

FIGS. 2(a) and 2(b) illustrate methods for collecting functional and physiological data, respectively. For magnetic resonance images (a1 in FIG. 2(a)), it is desirable to use echo planar imaging, which provides a high temporal resolution. For near-infrared spectra (a2 in FIG. 2(a)), it is desirable to use multi-channel measurement to obtain spatial information. In brain functional measurement, data is collected for periods of functional activation, in which a subject is stimulated or executes a task, and periods of baseline, in which the subject is not stimulated or executes no task. In these drawings, the rightward arrows indicate time axes, and the periods of activation and baseline alternate with each other. Unlike prior art, according to the invention, there is no need to repeat a certain combination of the periods of functional activation and the periods of baseline when collecting data. In addition, as shown in FIG. 2, the periods can have varied lengths even in one data collection. When only information about a local physiological function is to be extracted, any stimulus or task need not be given to the subject. In parallel with collection of the functional measurement data, physiological data, which serves as reference data for physiological fluctuations, is collected by measuring pulse waves, continuous arterial blood pressure (b1 in FIG. 2(b)), thoraco-abdominal movement, the concentration of carbon dioxide in expired gas (b2 in FIG. 2(b)) or the like. As described later, if a representative value of the functional measurement data is used as reference data, the physiological data need not be collected.

(2) Selection of a Region for Analysis

In the case where the magnetic resonance images are used as the functional measurement data, the region used for analysis is limited to an area of the imaged brain. In such a case, images can be segmented into the brain area and the background area based on a threshold that is set using a difference in signal intensity between the two areas. For some functional measurement data, this processing can be omitted. In the case where near-infrared spectra are used as the functional measurement data, this processing is not required.

(3) Preprocessing

On the data provided by the steps (1) and (2), means and trends are subtracted from measured signals on a pixel or channel basis to remove a direct current component and a very low frequency component. In addition, low-pass filtering for removing a high frequency component is applied. Furthermore, for a relevant frequency band, down sampling is performed. For some data, such preprocessing may be omitted.

(4) Generation of Input Signals

Data of brain functional activation paradigm and reference data of physiological fluctuation, which are used as input signals, are generated. Data of the brain functional activation paradigm is generated by assigning an arbitrary value to each of the period of function activation and the baseline period, and the values are desirably set in such a manner that the mean value over all the periods equals zero. Measured values of the continuous arterial blood pressure, concentration of carbon dioxide in expired gas or the like are used as the reference data of physiological fluctuation. However, in order to take some of the load off the subject when collecting data and simplifying the mathematical model described later, a representative value of the functional measurement data having undergone the processing (1), (2) and (3) can also be used. In this embodiment, an averaged signal over the whole brain is used as a representative value of the functional measurement data. If the functional measurement data contains a part exhibiting an abnormal signal behavior caused by a pathological condition, the measured values for the associated pixels or channels are excluded. If multi-slice magnetic resonance images are used, in order to adjust for variations in timing of image acquisition for the slices, the average value is calculated after interpolation for adjustment for variations in timing of image acquisition for the slices. As in the processing (3), means and trends are subtracted from these measured values to remove a direct current component and a very low frequency component. In addition, low-pass filtering for removing a high frequency component is applied. For some data, such processing may be omitted. In the case where the reference data of physiological fluctuation lags behind the functional measurement data, for example, in the case where the reference data of physiological fluctuation includes the concentration of carbon dioxide in expired gas sampled as a side stream, measured values are used as input signals after adjustment for time lags. If the sampling rate of the reference data of physiological fluctuation differs from that of the functional measurement data, the sampling rates are adjusted by re-sampling so as to be identical to each other.

(5) Creation of a Mathematical Model

Any black box model structures including a non-linear model and time-varying model as well as a linear model and a time-invariant model can be used. Although activities of a living body are non-linear and time-variant in general, an approximation based on linear and time-invariant system is sufficiently accurate in the range of stable physiological condition and in a relatively short period of measurement. In this embodiment, an auto-regressive model with exogenous inputs (ARX model), model parameters of which are easy to calculate, will be described (see “Signal Analysis and System Identification”, Takayoshi Nakamizo, CORONA PUBLISHING CO., LTD, “System Identification for Control by MATLAB”, Shuichi Adachi, Tokyo Denki University Press, and “System Identification Toolbox User's Guide Version 5”, Ljung L, The Mathworks, Inc.). The following is a formula representing the model structure.

A(q)y(k)=B(q)u(k−nₖ)+w(k) (1)

In this formula, y(k) denotes an output signal of the system, u(k) denotes an input signal of the system, nₖ denotes a dead time, w(k) denotes a white noise having a mean value of 0 and a finite variance, and A(q) and B(q) denote polynomials of a shift operator q.

Using the measured values for pixels or channels as an output and using the data of brain functional activation paradigm and the reference data of physiological fluctuation as inputs, the model parameters are estimated. Estimation of the ARX model parameters is based on the least squares method. However, if an auto-regressive moving average model with exogenous inputs (ARMAX model) is used, estimation of model parameters is based on the maximum likelihood method or the like (see “Signal Analysis and System Identification”, Takayoshi Nakamizo, CORONA PUBLISHING CO., LTD).

A suitable model structure (order) is selected by cross-validation, minimal realization, information criterion or the like (see “Signal Analysis and System Identification”, Takayoshi Nakamizo, CORONA PUBLISHING CO., LTD, and “System Identification for Control by MATLAB”, Shuichi Adachi, Tokyo Denki University Press). In this embodiment, in order for the operator to be less involved in processing of the measured data for a large number of pixels or channels, the suitable model structure (order) is automatically selected by information criterion or selected by the operator referring to the set of model orders selected automatically. The Akaike Information Criterion is used as the information criterion for automatic selection of model structure (order) (see “Statistical Analysis and Control of Dynamic System (newly-revised edition)”, Hirotsugu Akaike and Toichiro Nakagawa, SAIENSU-SHA CO., LTD, and “Method of Time-Series Analysis”, edited by Toru Ozaki and Genshiro Kitagawa, Asakura Shoten). Similarly, the dead time nₖ is also selected by impulse response using correlation, cross-validation, information criterion or the like. For some data, the dead time may be fixed at 0.

When the averaged signal over the whole brain is used as an input, a part of the brain may exhibit a signal change preceding a change in the averaged signal over the whole brain. Thus, the time delay of the averaged signal over the brain is adjusted. The amount of adjustment is determined by cross-validation or by an operator's choice based on a known transit time. For some data, this processing may be omitted.

When only information about a local physiological function is to be extracted, a model driven by the reference data of physiological fluctuation as an input is used. A multivariate time-series model is used for extracting information on a local physiological function combined with feedback relations between various kinds of physiological activities from a set of the functional and physiological data (see “Statistical Analysis and Control of Dynamic System (newly-revised edition)”, Hirotsugu Akaike and Toichiro Nakagawa, SAIENSU-SHA CO., LTD, and “Method of Time-Series Analysis”, edited by Toru Ozaki and Genshiro Kitagawa, Asakura Shoten). For extracting a signal change caused by a physiological activity for which no distinct input can be specified, for example, vasomotion, modeling is achieved using reference data of other physiological sources of fluctuation and stochastic noise as inputs. Or, if effects of the other physiological sources of fluctuation can be excluded, a time-series model is used.

(6) Visualization of the Result

The model parameters estimated for the pixels or channels can be displayed in a polynomial representation, a transfer function representation, a zero-pole-gain representation or the like. Alternatively, they can be displayed as a frequency transfer function. Model properties, such as zeros and poles, can be displayed as a distribution on a complex plane or a map representation showing a spatial distribution for a operator-selected frequency-band.

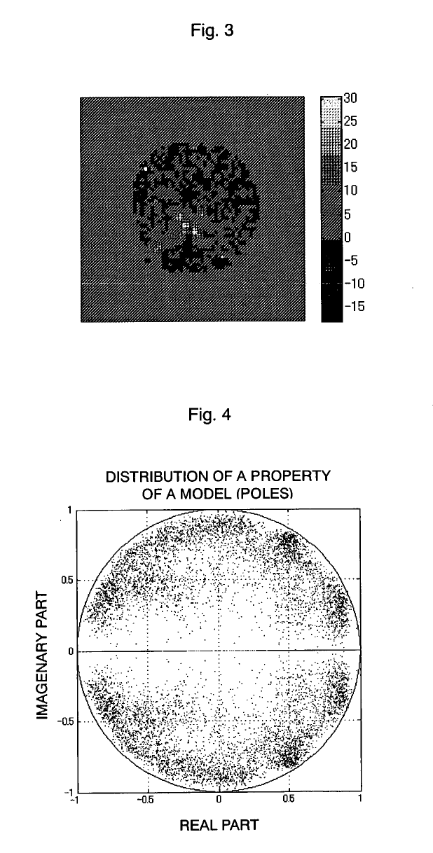

FIG. 3 is a map showing a spatial distribution of gains corresponding to a brain functional activation input based on a model obtained by applying the invention to magnetic resonance imaging data of human brain for a visual stimulation experiment. The value of gain for each pixel is indicated by gray-scale.

FIG. 4 is a graph showing a distribution of a property of a model (poles) on the complex plane. The model is obtained by applying the invention to magnetic resonance imaging data of human brain and reference data of physiological fluctuation (end-tidal concentration of carbon dioxide) in a resting state.

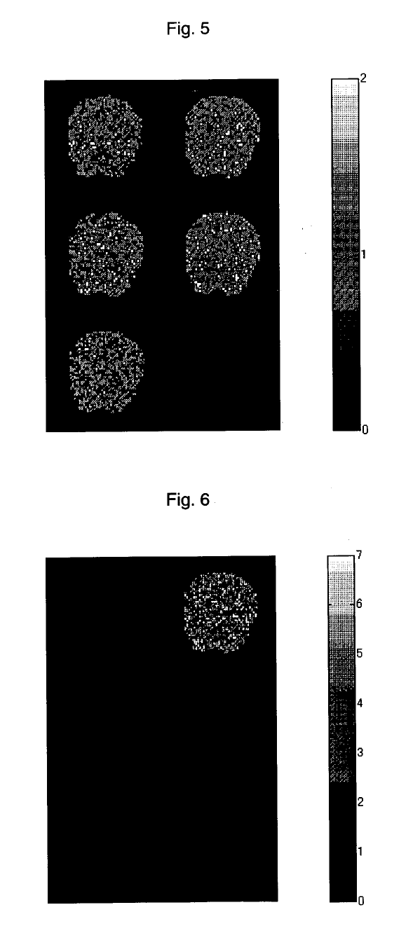

FIGS. 5 and 6 are maps showing spatial distributions of properties of a model (poles and zeros, respectively) obtained by applying the invention. In these examples, for each of frequency bands of 0.008 to 0.05 Hz, 0.05 to 0.10 Hz, 0.10 to 0.15 Hz, 0.15 to 0.20 Hz and 0.20 to 0.25 Hz, the number of poles or zeros for each pixel is shown by an image. The images for these frequency bands are arranged from top left to right bottom. Here, the right bottom is a blank. The number of poles or zeros is indicated by gray-scale. In FIG. 6, only the top-right image for the frequency band of 0.05 to 0.10 Hz is visible.

The strength of stochastic noise can be transformed into a variance, a standard deviation, a coefficient of variation or the like and visualized as a graph showing the distribution or a map showing the spatial distribution thereof.

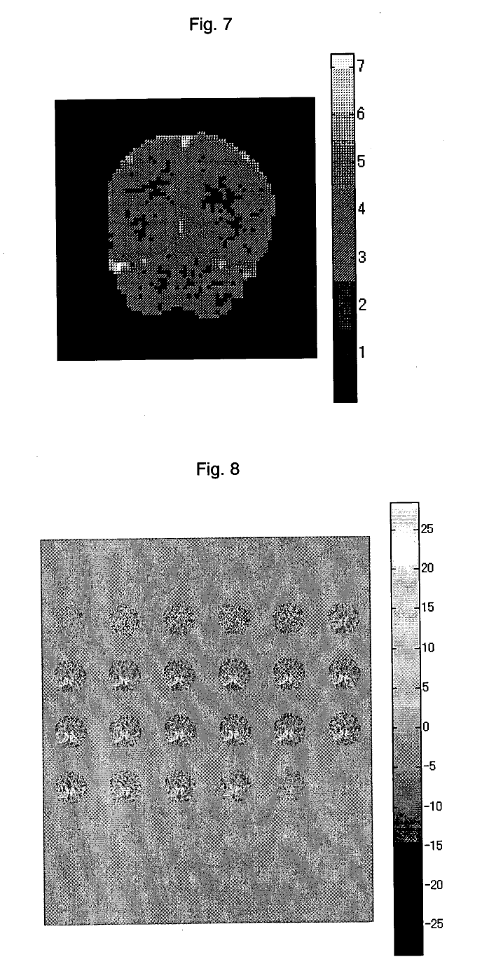

FIG. 7 is a map showing a spatial distribution of strength of stochastic noise of a model that is obtained by applying the invention to magnetic resonance imaging data of human brain and reference data of physiological fluctuation (end-tidal concentration of carbon dioxide) in a resting state. The strength of stochastic noise is indicated by gray-scale. In this example, the visualization scale is a common logarithm of a value obtained by adding 1 to the variance of the stochastic noise for each pixel.

When performing simulation based on a model, an impulse response, a step response or any response to arbitrary input waveform designated by the operator is visualized. The response can be visualized by a graph showing a time-course change in the output with reference to a point in time when input is started or by a map showing spatial distribution of signal values after a lapse of time specified by the operator.

The validity of the estimated model can be checked by comparing the measured signals and the results of simulation driven by actual inputs.

FIG. 8 shows a result of simulation of time-course signal changes in human brain in the case where a pulsed waveform is given as a brain functional activation input to a model. This model is obtained by applying the invention to magnetic resonance imaging data of human brain for a visual stimulation experiment. In this example, an input pulse having a duration of 8 seconds and a strength of 1 is applied to the model, and the responses in the brain to the input pulse are visualized by images at an interval of 0.5 seconds arranged from top left to bottom right. The image located at the left end in the second row from the top corresponds to the time when the input is started, and the image located in the fourth column from the left and in the fourth row from the top corresponds to the time when the input is completed. Changes in signal intensity in the brain in response to the input are indicated by gray-scale.

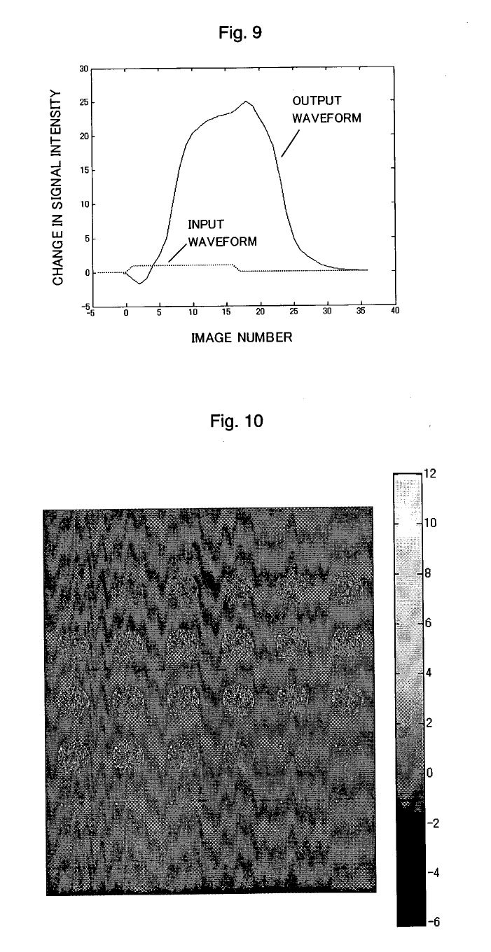

FIG. 9 is a graph showing a result of simulation of time-course signal change for one pixel in the occipital lobe. The horizontal axis indicates time in terms of image number, the image number 1 being assigned to the image obtained when input is started. The vertical axis indicates the change in signal intensity. As a reference, the input waveform is also shown.

FIG. 10 shows a result of simulation of time-course signal changes in human brain in the case where a pulsed input waveform is given as a change in averaged signal over the whole brain to the above-described model. In this example, an input pulse having a duration of 8 seconds and a strength of 1 is applied to the model, and the responses in the brain to the input pulse are visualized by images at an interval of 0.5 seconds arranged from top left to bottom right. The image located at the left end in the second row from the top corresponds to the time when input is started, and the image located in the fourth column from the left and in the fourth row from the top corresponds to the time when input is completed. Changes in signal intensity in the brain in response to the input are indicated by gray-scale.

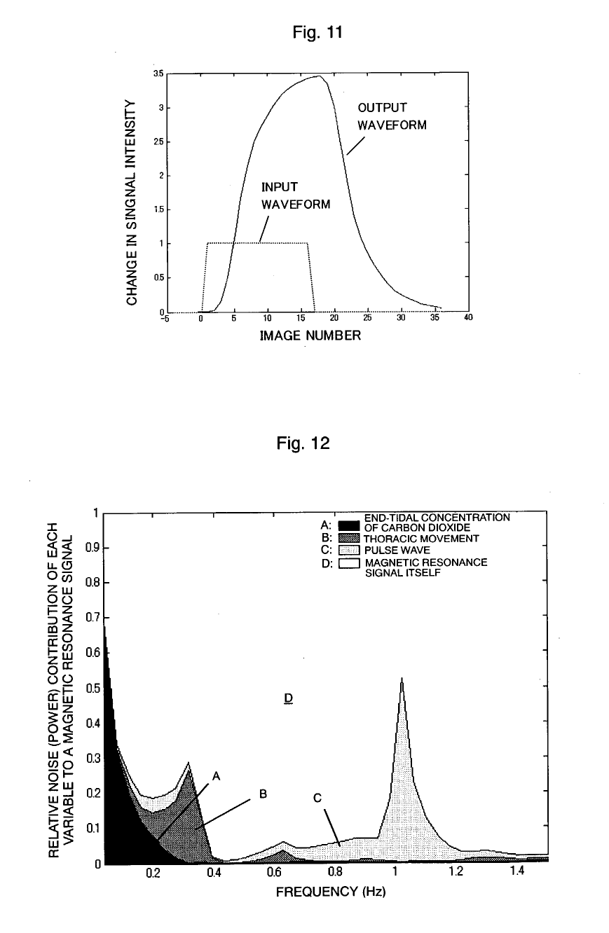

FIG. 11 is a graph showing a result of simulation of time-course signal change for one pixel in the parietal lobe. The horizontal axis indicates time in terms of image number, the image number 1 being assigned to the image obtained when input is started. The vertical axis indicates the change in signal intensity. As a reference, the input waveform is also shown.

In this embodiment, one type of input is used for a brain functional activation paradigm. However, the invention can be applied to a brain function activation paradigm using multi-modal inputs.

In this embodiment, single-slice magnetic resonance imaging is used. However, also in the case of multi-slice data, each of the slices can be handled in the same procedure. In such a case, variations in timing of image acquisition for the slices are adjusted before processing.

In this embodiment, a batch processing after collection of all the data has been described as an example. However, if a recursive computation algorithm is used (see “Signal Analysis and System Identification”, Takayoshi Nakamizo, CORONA PUBLISHING CO., LTD, and “System Identification for Control by MATLAB”, Shuichi Adachi, Tokyo Denki University Press), an on-line or real-time processing is possible.

In this embodiment, extraction of information on brain functional activation for a human being has been described as an example. However, the invention can be applied to any organ or tissue other than brain or any animal other than human beings.

If a time-series model is used, model parameters can be visualized as it is or in another form, model properties can be visualized, frequency domain information such as a power spectrum, cross spectrum or coherence function can be visualized, or the strength of stochastic noise can be visualized. In addition, a result of a simulation based on the model can also be visualized. When noises of variables are not correlated with each other, a multivariate auto-regressive model can display a closed-loop frequency response function and a noise contribution (or power contribution) even if there is a feedback between variables in the system (see “Statistical Analysis and Control of Dynamic System (newly-revised edition)”, Hirotsugu Akaike and Toichiro Nakagawa, SAIENSU-SHA CO., LTD, and “Method of Time-Series Analysis”, edited by Toru Ozaki and Genshiro Kitagawa, Asakura Shoten).

FIG. 12 is a graph showing relative noise contributions of variables to a magnetic resonance signal based on a model obtained by applying the invention to magnetic resonance imaging data of human brain and reference data of physiological fluctuations (pulse wave, thoracic movement and end-tidal concentration of carbon dioxide) in a resting state. The horizontal axis indicates the frequency and the vertical axis indicates relative noise (power) contribution of each variable to a magnetic resonance signal. In this drawing, reference character A denotes the end-tidal concentration of carbon dioxide, reference character B denotes the thoracic movement, reference character C denotes the pulse wave and reference character D denotes the magnetic resonance signal itself.

Furthermore, based on models obtained by applying the invention, a map showing a spatial distribution of a noise (power) contribution of each variable to the functional measurement data can be visualized in a frequency-band selective manner.

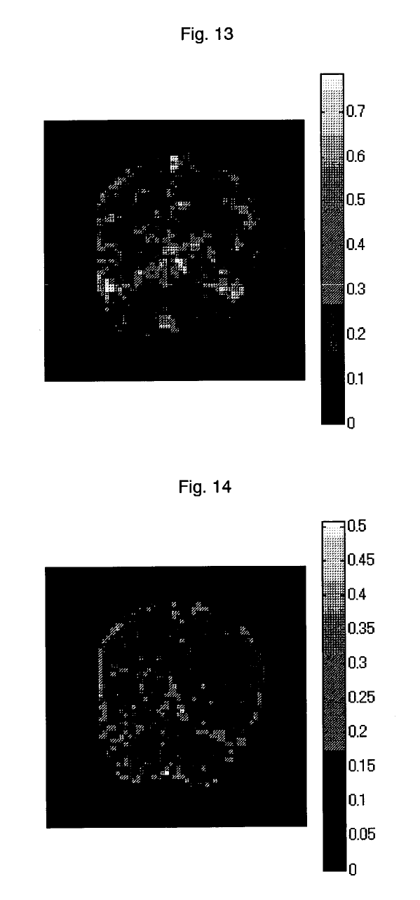

FIG. 13 is a map showing a spatial distribution of a noise (power) contribution of a pulse wave to magnetic resonance signals within a frequency band of 0.98 to 1.10 Hz, based on a model obtained by applying the invention. The noise (power) contribution of the pulse wave is indicated by gray-scale.

FIG. 14 is a map showing a spatial distribution of a noise (power) contribution of a thoracic movement to magnetic resonance signals within a frequency band of 0.24 to 0.36 Hz, based on a model obtained by applying the invention. The noise (power) contribution of the thoracic movement is indicated by gray-scale.

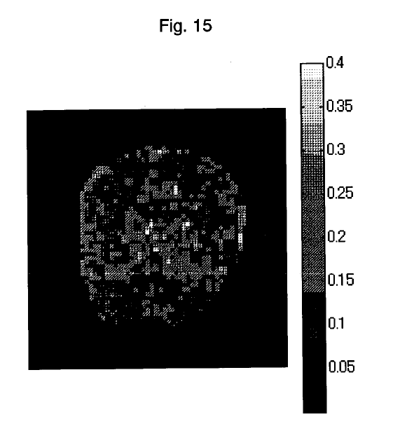

FIG. 15 is a map showing a spatial distribution of a noise (power) contribution of an end-tidal concentration of carbon dioxide to magnetic resonance signals within a frequency band of 0.04 to 0.16 Hz, based on a model obtained by applying the invention. The noise (power) contribution of the end-tidal concentration of carbon dioxide is indicated by gray-scale.

In this embodiment, a map showing a spatial distribution of a noise (power) contribution is created for each variable. However, information on multiple variables can be visualized on one synthetic color map by allocating a color to each variable.

In addition, as for any variable, a response to an input can be visualized by simulation (see “Method of Time-Series Analysis”, edited by Toru Ozaki and Genshiro Kitagawa, Asakura Shoten and “Practice of Time-Series Analysis I”, edited by Hirotsugu Akaike and Genshiro Kitagawa, Asakura Shoten).

For example, an apparatus for separating and extracting information on physiological functions according to the invention can build, by means of a computer, a mathematical model that describes an input/output relationship for functional measurement data on a pixel or channel basis, thereby separating and extracting information on signal components of different physiological origins from signals of the functional measurement data. The separated and extracted information on physiological function can be visualized on a display device connected to the computer.

According to the invention, unlike well-known extracting methods, such as those using a statistical test for difference in mean values or correlation, the invention does not require a presupposed pattern of signal changes in functional measurement data caused by stimulation or executing a task. In addition, according to the invention, since any smoothing processing, which is intended to provide event independence essential for a statistical test, is not required, the resolution of the functional measurement data is not degraded. Unlike the case of independent component analysis, according to the invention, there is no need to interpret the physiological origins of the decomposed signal components. According to the invention, even if a physiological fluctuation other than local neuronal activities is contained in the functional measurement data, the information about the local neuronal activities can be accurately extracted. In addition, information about various physiological functions other than local neuronal activities can also be extracted.

What is claimed is:

1. A method for separating and extracting information on physiological functions, wherein a mathematical model is built to describe an input/output relationship for functional measurement data on a pixel or channel basis, and information on signal components of various physiological origins is separated and extracted from the functional measurement data.

2. The method for separating and extracting information on physiological functions according to claim 1, wherein the extracted information is a function of a central nervous system.

3. The method for separating and extracting information on physiological functions according to claim 1, wherein the extracted information is a local physiological function.

4. The method for separating and extracting information on physiological functions according to claim 1, wherein a representative signal value of the functional measurement data is used in building the mathematical model.

5. The method for separating and extracting information on physiological functions according to claim 1, wherein measured values of systemic physiological functions are used in building the mathematical model.

6. The method for separating and extracting information on physiological functions according to claim 1, wherein stochastic noise is used in building the mathematical model.

7. The method for separating and extracting information on physiological functions according to claim 1, wherein the separated and extracted information on physiological functions is visualized.

8. The method for separating and extracting information on physiological functions according to claim 7, wherein simulation based on the model is used for visualizing the information on physiological functions.

9. The method for separating and extracting information on physiological functions according to claim 7, wherein a distribution of or spatial information about noise contribution (power contribution) is used for visualizing the information on physiological functions.

10. The method for separating and extracting information on physiological functions according to claim 7, wherein a distribution of or spatial information about model properties is used for visualizing the information on physiological functions.

11. The method for separating and extracting information on physiological functions according to claim 7, wherein a distribution of or spatial information about stochastic noise is used for visualizing the information on physiological functions.

12. An apparatus for separating and extracting information on physiological functions, comprising means for building a mathematical model which describes an input/output relationship for functional measurement data on a pixel or channel basis, and separating and extracting information on signal components of various physiological origins from the functional measurement data.

13. The apparatus for separating and extracting information on physiological functions according to claim 12, further comprising means for visualizing the separated and extracted information on physiological functions.
